(19) United States
(12) Patent Application Publication
(10) Pub. No.: US 2002/0111831 A1
(43) Pub. Date: Aug. 15, 2002

(54) Information service system at hospital, nursing home or other institute

(76) Inventor: Toshihiko Harada, Tokyo (JP)

Correspondence Address: Duane Morris LLP, 1667 K Street, N.W., Washington, DC, 20006, US

(21) Appl. No.: 09/811,562

(22) Filed: Mar. 20, 2001

(30) Foreign Application Priority Data
Feb. 13, 2001 (JP) 2001-035542

(51) Int. Cl. G06F 17/60

(52) U.S. Cl. 705/3; 705/41

(57) ABSTRACT

In the light of the present situation of other services than medical and care jobs presented to the inpatients, inhabitants and users in hospital, nursing home and other institutes, it is intended to present an information service system capable of improving and expanding both quality and quantity of available services. The system comprises a terminal having a display screen including touch panel type input means disposed as an input and output terminal 7 in each patient room 2 or waiting room 3 at hospital, nursing home or other institute, terminal 11 to 13 as input and output means connected to the input and output terminal 7 for handling input information from the terminal 7 and output information to the terminal 7, and server computers 9, 10 connected to external information sources 15 to 17 through a communication network 16 such as the Internet, in which information such as broadcast and other video and audio data, guide data relating to medical and care jobs, pulse rate and other measurement data, supplies and other order data, interview data, meal menu selection data, and drug retrieval data can be exchanged between the terminals 7, 11 to 13 and the server computers 9, 10.

### BACKGROUND OF THE INVENTION

1. Field of the Invention

The present invention relates to an information service system used in hospital, clinic, nursing home, and other medical and care institutes, for presenting various services that can be handled by laypeople not qualified as physician, nurse or care manager, by using a personal computer having a display screen with a touch panel or other terminal installed in patient room, care room, waiting room and others, which is designed to be used by patients, family members, visitors and other people not qualified as nurses or the like, so that the medical and care information, and other various information may be obtained at hand by the user by displaying the information on the screen.

2. Description of the Related Art

At the present, the hospitals, nursing homes and the like are chronically understaffed, and inpatients and inhabitants cannot sufficiently receive various indirect services relating to the medical and care services. For example, if an inpatient complains illness or pain, hitherto, a nurse is fetched by so-called nurse call, and the own symptom is verbally expressed, but if nurses are attending other patients and the nurse center is vacant, such nurse call is useless.

Or if an inpatient or inhabitant desires to see television broadcast or video movie in the own room, the TV set or video player must be individually brought into the room, and the limited space of the room is further narrowed and complicated.

If a patient wishes to buy some daily article, the patient, if not allowed to leave the room, must ask the attendant.

### SUMMARY OF THE INVENTION

In the light of the present situation of other services than medical and care jobs presented to the inpatients, inhabitants and users in hospital, nursing home and other institutes, it is hence an object of the invention to present an information service system capable of improving and expanding both quality and quantity of available services.

To solve the problems, the information service system of the invention comprises a terminal having a display screen including touch panel type input means disposed as an input and output terminal in patient room or waiting room at hospital, nursing home or other institute, a terminal as input and output means connected to the input and output terminal for handling input information from the terminal and output information to the terminal, and a server computer connected to an external information source or the like through a communication network such as the Internet, in which information such as broadcast and other video and audio data, guide data relating to medical and care jobs, pulse rate and other measurement data, supplies and other order data, interview data, meal menu selection data, and drug retrieval data can be exchanged between the terminal and the server computer.

In the system of the invention, for example, input and output terminals connected to the server computer are installed at nurse center, accounting department, shops, and other proper places in the institute.

In the server computer, a database of inpatient medical cards, medical dictionary, pharmaceutical dictionary, electronic money management and others is built up.

Further in the system of the invention, issuing means of prepaid card, IC card or other electronic money medium connected to the server computer is installed in the institute to offer charged services from the institute.

The external information source in the system of the invention includes television broadcast and pay broadcast program.

### BRIEF DESCRIPTION OF THE DRAWING

FIG. 1 is a block diagram showing schematically a configuration of an information service system of the invention.

### DESCRIPTION OF THE PREFERRED EMBODIMENT

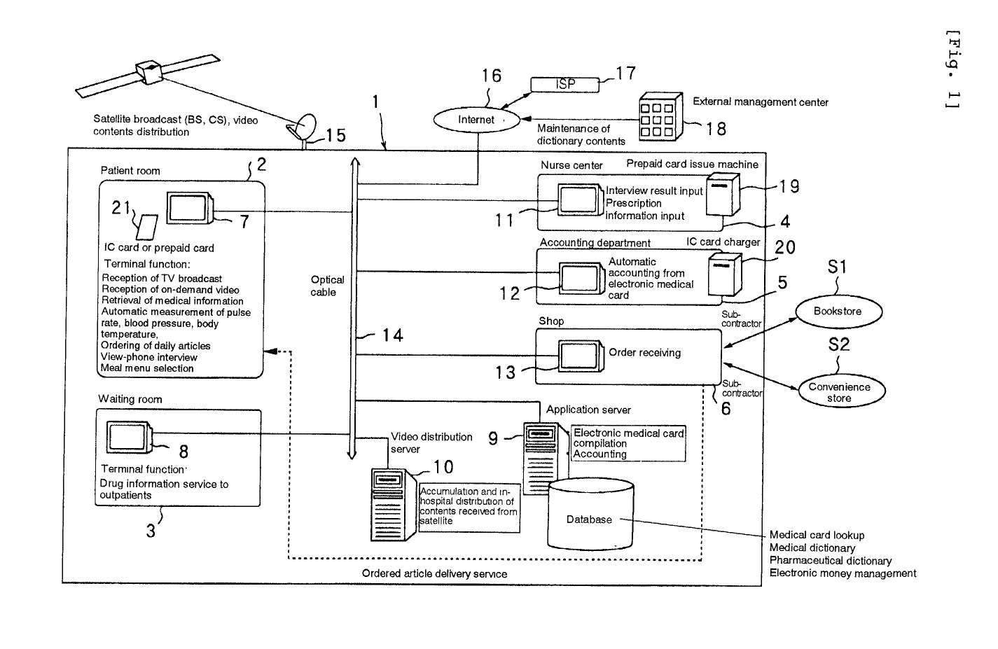

An example of information service system of the invention is described below by referring to the accompanying drawing. FIG. 1 is a block diagram showing schematically a configuration of an information service system of the invention.

In FIG. 1, reference numeral 1 conceptually shows an institute in which the information service system of the invention can be applied, and a hospital is shown as an example. This hospital 1 accommodates patient room 2, waiting room 3, nurse center 4, accounting department 5, and shop 6. The number of patient rooms 2 to shops 6 is not limited and arbitrary for management of this system.

In the patient room 2 and waiting room 3, terminals 7, 8 of a personal computer or the like having a display screen of touch panel type are installed.

Inside the hospital 1, further, a server computer 9 incorporating a database relating to medical card compilation, lookup, accounting, and professional dictionaries is installed. In the shown example, there is also a server computer 10 for distributing various contents within the hospital, such as movies transmitted through satellite broadcast, other video data, audio data, and text data.

In the nurse center 4, accounting department 5, and shop 6 in the hospital 1, input and output terminals 11, 12, 13 are installed, and these terminals 11 to 13, and the terminals 7, 8 are connected to the server computers 9, 10 through data bus 14 such as optical cable. Moreover, these server computers 9, 10 are designed to be connected to an Internet provider 17 and a management center 18 as external information supply sources through a communication network such as the Internet 16. The input means of the terminals 11 to 13 may be either touch panel or keyboard.

In this system, in order to present non-medical services at due charges from the hospital 1, a prepaid card issue machine 19, an IC card charger 20, and other vending machine of electronic money medium 21 such as prepaid card and IC card are installed at proper places in the hospital, and for example, the use of the terminal 7 in each patient room 2 may be charged and settled by the prepayment system by using the medium 21. Of course, in this system, the terminal 7 may be used at no charge. Or, depending on the purpose of use of the terminal 7, its use may be charged or not. In the case of charged management of the terminal 7, the data of charge rate and time can be managed by the server computer 9 at the terminal 7 of each patient room 2.

In the information service system of the present invention having such configuration, an example of operation of the system is explained.

The terminal 7 of the patient room 2 has, for example, functions for (a) reception of TV broadcast, (b) reception of on-demand video, (c) retrieval of medical guide, (d) measurement of pulse rate, blood pressure, and body temperature, (e) ordering of daily articles, sundries and books, (f) view-phone interview, and (g) meal menu selection. For this purpose, the touch panel of the terminal 7 is divided into items (a) to (g), and the user of the terminal 7 selects any one of items (a) to (g) by touching the corresponding display screen, and the display screen of the terminal 7 shows corresponding to the selected item, and a single function of the item is put in action.

In this case, for example, when the on-demand video reception of selected item (b) is a charged service, the user inserts the medium 21 such as prepaid card or IC card into a specified position (reader) of the terminal 7 to have the data read, and the function relating to the item (b) is executed by the terminal 7. In the case of measurement of pulse rate, etc. of (d), there is independent measuring means connected to the terminal 7, and the measured value of each measuring means is entered into the terminal 7. Or, for the measurements, a measuring sensor is disposed in the touch panel of the terminal 7, and by putting the palm on the sensor, the pulse rate, blood pressure and body temperature of the patient are measured, and measured values are entered in the terminal 7. When the items (a) to (g) are selected at the terminal 7, the server computer 9 or 10 is connected.

The terminal 7 installed at the waiting room 8 has a function of, for example, searching the drugs supplied to outpatients, or includes a terminal device having receiving function of TV broadcast or the like.

The terminal 11 at the nurse center 4 has a function of exchanging information about inquiry and reply with the terminal 7 in the patient room 2 through the server computer 9, and storing the results of interview in the server computer 9, or also has a function of entering the prescription data about the patient in the room 2 and storing in the server computer 9.

The terminal 12 installed in the accounting department 5 has a function of automatically calculating the medical expenses on the basis of the prescription data (medication, injection, treatment, etc.) of paper or electronic medical card filled by the physician, and sending the data to the server computer 9.

The terminal 13 at the shop 6 receives orders for daily articles, sundries or books sent from the terminal 7 in each patient room 2, and delivers the ordered items to the client (the inpatient in the room 2), either directly if available in stock, or after purchasing from subcontractors such as a bookstore S1 or a convenience store S2 if out of stock. The account is processed by settling through the medium 21 or by cash on delivery. In the case of settlement by card or medium 21, the order data and settlement data are stored in the server computer 9.

When receiving the pay broadcast or video distribution at the terminal 7 in the room 2, the pay reception function of the terminal 7 is executed by the medium 21 such as card, and the pay contents are distributed through the server computer 10, and the charge is settled. In this case, the pay distribution data and settlement data are also stored in the server computer 9.

In this system, moreover, a demand call, instead of nurse call, can be sent from the terminal 7 in the room 2, and the patient's request may be displayed and noticed in the terminal 11 at the nurse center 4.

Or when retrieval of medical guide is selected in item (c) at the terminal 7, for example, the name and indication of the drip infusion or the drug being administered are displayed on the screen of the terminal 7, so that the patient can obtain the knowledge of the drug.

Further, when measurement of pulse rate, blood pressure, and body temperature (d) is selected, the measured data are sent from the terminal 7 to the nurse center 4, from which it is further stored in the database of the server computer 9, or by using the terminal 7 in the room 2 and the terminal 11 at the nurse center 4, interview by attending physician or nurse is possible. In addition, for inpatients not limited in the diet, the item (g) can be selected in the terminal 7, and a desired meal menu can be selected from the display screen, and it can be transmitted to the nurse center 4.

This embodiment is an application example of the information service system of the invention in a hospital, but the system of the invention may be also applied in nursing home, and other medical or similar institutes.

As described herein, the system of the invention relates to peripheral services needed by inpatients and inhabitants, excluding medical activities and medical services, that can be presented by non-qualified people, that is, the information relating to peripheral services requested by a patient is transmitted to a proper party, and the party receiving this information reacts to satisfy the request of peripheral service or related service, and it helps the nurses and other staff to be solely engaged in medical and care activities by liberating from non-medical services, while the patients can enjoy quick and adequate responses concerning peripheral services and related services.

Moreover, the system of the invention creates a new occupation in the hospital or nursing home that can be operated by laypeople not qualified as physicians and nurses, so that it is very effective for developing a new job category in the medical institutes.

What is claimed is:

1. An information service system at hospital, nursing home or other institute comprising a terminal having a display screen including touch panel type input means disposed as an input and output terminal in patient room or waiting room at hospital, nursing home or other institute, a terminal as input and output means connected to said input and output terminal for handling input information from said terminal and output information to said terminal, and a server computer connected to an external information source or the like through a communication network such as the Internet, wherein information such as broadcast and other video and audio data, guide data relating to medical and care jobs, pulse rate and other measurement data, supplies and other order data, interview data, meal menu selection data, and drug retrieval data can be exchanged between the terminal and the server computer.

2. The information service system of claim 1, wherein input and output terminals connected to said server computer are installed at nurse center, accounting department, shops, and other proper places in the institute.

3. The information service system of claim 1, wherein a database of inpatient medical cards, medical dictionary, pharmaceutical dictionary, electronic money management is built up in the server computer.

4. The information service system of claim 2, wherein a database of inpatient medical cards, medical dictionary, pharmaceutical dictionary, electronic money management is built up in the server computer.

5. The information service system of claim 1, wherein issuing means of prepaid card, IC card or other electronic money medium connected to the server computer is installed in the institute to offer charged services from the institute.

6. The information service system of claim 2, wherein issuing means of prepaid card, IC card or other electronic money medium connected to the server computer is installed in the institute to offer charged services from the institute.

7. The information service system of claim 3, wherein issuing means of prepaid card, IC card or other electronic money medium connected to the server computer is installed in the institute to offer charged services from the institute.

8. The information service system of claim 4, wherein issuing means of prepaid card, IC card or other electronic money medium connected to the server computer is installed in the institute to offer charged services from the institute.
